(19) United States
(12) Patent Application Publication
(10) Pub. No.: US 2014/0164002 A1
(43) Pub. Date: Jun. 12, 2014

(54) JOINT DECODING APPARATUS AND METHOD, NECESSITY JUDGING METHOD AND APPARATUS, AND RECEIVER

(71) Applicant: FUJITSU LIMITED, Kawasaki-shi (JP)

(72) Inventors: Lei ZHANG, Beijing (CN); Xin WANG, Beijing (CN); Hua ZHOU, Beijing (CN); Jianming WU, Beijing (CN); Xiaolei HAN, Shang Hai (CN); Xiaoqun ZHAO, Shang Hai (CN); Nan ZHANG, Shang Hai (CN); Tenglong FANG, Shang Hai (CN)

(73) Assignee: FUJITSU LIMITED, Kawasaki-shi (JP)

(21) Appl. No.: 14/090,451

(22) Filed: Nov. 26, 2013

Related U.S. Application Data
(63) Continuation of application No. PCT/CN2011/074777, filed on May 27, 2011.

(51) Int. Cl. G10L 19/005

(52) U.S. Cl. CPC G10L 19/005
USPC 704/504

(57) ABSTRACT

A Joint Source-Channel Decoding (JSCD) apparatus, method, necessity judging method, and a receiver includes: a source coding rate change judging unit configured to judge whether a source coding rate of the current frame is the same as the previous frame; a source coding rate eligibility judging unit configured to judge whether the source coding rate of the current frame is less than a predetermined source coding rate threshold; a current frame SIR eligibility judging unit configured to judge whether an SIR of the current frame is lower than a predetermined SIR threshold, a necessity result determining unit configured to determine that a JSCD is necessary, when the source coding rate of the current frame is the same as the previous frame, the source coding rate of the current frame is less than the source coding rate threshold, and the SIR of the current frame is lower than the SIR threshold.

### CROSS-REFERENCE TO RELATED APPLICATIONS

This is a continuation of International Application No. PCT/CN2011/074777, filed on May 27, 2011 and now pending, the contents of which are herein wholly incorporated by reference.

### TECHNICAL FIELD

The present invention relates to a receiver and a receiver decoding method.

### BACKGROUND

The Shanon separate coding principle is the design basis for the current multimedia communication system, wherein the source coding effectively compresses the source data based on the source statistical characteristics, and the channel coding increases the robustness of the data transmission to realize a reliable transmission. The source coding and the channel coding of the communication system are independently designed in their respective structures, thereby reducing the complexity of the system design. However, according to the Shanon separate coding principle, the independently designed system obtains the optimum system performance only when the code word is infinitely long (which means that the complexity and the delay are infinitely large) and in the environment of point to point communication, which prompts the study and development of the joint source-channel coding and decoding algorithms.

Currently in the channel coding, the Long Term Evolution-Advanced (LTE-A) system still mainly uses the R6 Turbo coding as the LTE system channel coding, and it also introduces the Tail Biting convolution code. Meanwhile, many companies are studying other coding method, such as the Low-Density Parity-Check (LDPC) code. The LDPC code and the Turbo code achieve the objective of approaching the Shannon limit in their respective manners. The idea of the current Joint Source-Channel Decoding (JSCD) based on LDPC is to combine the Hidden Markov source estimation, and perform an LDPC coding of the multimedia source having redundancy at the transmitting end, while performing a joint decoding by using a decoding method which joints the source estimation and the channel decoding at the receiving end. However, in the process of joint iterative decoding, the iteration number in the LDPC decoding is high, a large storage capacity is required for the matrix generation, and the real-time performance is poor, thus the application of the technology in the practical system is limited.

In addition, the Adaptive Multi Rate (AMR) speech coding is a new speech coding technology established by the 3rd Generation Partnership Project (3GPP) after EFR, FR and HR. The core idea is to automatically select appropriate coding and decoding algorithms according to the changes of the uplink signal quality and downlink signal quality, and solve the problem of rate distribution in the source coding and channel coding more intelligently, so that the allocation and utilization of the wireless resources are more flexible and effective. The coding characteristics are as follows:

1) The AMR-NB supports multiple coding rates: 12.2 kb/s, 10.2 kb/s, 7.95 kb/s, 7.40 kb/s, 6.70 kb/s, 5.90 kb/s, 5.15 kb/s and 4.75 kb/s. In addition, it also includes a low rate (1.80 kb/s) background noise coding method.

2) The speech coding rate depends on the channel condition: as compared with the current fixed coding rate adopted by GSM speech coding, the AMR speech coding can adaptively select an optimum channel mode (full rate or half rate) and coding mode (distinguished based on bit rate) according to the wireless channel and the transmission situation, to perform a code transmission.

3) Unequal error protection strategy: the AMR core frame carries the coded information of speech or noise, and the bits generated by the speech coder are sorted into three types according to their subjective importance: types A, B and C, which are suitable for different error protection levels in the network. Type A includes bits most sensitive to the error, and when any one of those bits is erroneous, the decoding will not be performed unless the error is concealed appropriately; this type performs a check and protection by using the CRC in the AMR auxiliary information. When the bits of either type B or type C are erroneous, the speech quality is lowered, but if it is accepted in subjective feeling, the error speech frame can also be decoded directly; the bits of type B are more sensitive to the error than the bits of type C.

In the current decoding method, the characteristic of the AMR variable rate speech coding is not sufficiently utilized.

### SUMMARY

In view of the above problems of the prior art, the present invention is proposed to solve one or more shortages due to the limitation of the prior art, and provides at least one beneficial choice.

In order to achieve the above objective, according to an aspect of the present invention, a Joint Source-Channel Decoding (JSCD) necessity judging apparatus is provided, the apparatus includes a source coding rate change judging unit configured to judge whether a source coding rate of the current frame is the same as that of the previous frame; a source coding rate eligibility judging unit configured to judge whether the source coding rate of the current frame is less than a predetermined source coding rate threshold; a current frame Signal to Interference Ratio (SIR) eligibility judging unit configured to judge whether an SIR of the current frame is lower than a predetermined SIR threshold; and a necessity result determining unit configured to determine that a JSCD is necessary, when the source coding rate of the current frame is the same as that of the previous frame, the source coding rate of the current frame is less than the source coding rate threshold, and the SIR of the current frame is lower than the SIR threshold.

According to another aspect of the present invention, a JSCD necessity judging method is provided, the method includes: judging whether a source coding rate of the current frame is the same as that of the previous frame; judging whether the source coding rate of the current frame is less than a predetermined source coding rate threshold; judging whether an SIR of the current frame is lower than a predetermined SIR threshold; and determining that a JSCD is necessary when the source coding rate of the current frame is the same as that of the previous frame, the source coding rate of the current frame is less than the source coding rate threshold, and the SIR of the current frame is lower than the SIR threshold.

According to the embodiment of the present invention, the coding rate is used as the judging mechanism, and the channel condition is considered, thus the performance of the LTE-Advanced system can be improved.

According to another aspect of the present invention, a JSCD apparatus is provided. The JSCD apparatus includes: a Turbo decoding unit configured to decode a received signal; a deframing unit configured to deframe the received signal decoded by the Turbo decoding unit to obtain a source coding rate; a wrong speech frame judging unit configured to determine whether the current frame is a wrongly received speech frame; a JSCD necessity judging apparatus configured to judge whether a JSCD is necessary according to the source coding rate obtained by the deframing unit; and a joint decoding unit configured to perform a JSCD by using cyclic iterative operations of a bit estimating unit and the Turbo decoding unit.

In an embodiment, the JSCD apparatus further includes a maximum number of times of iterations setting unit and/or a Turbo decoding method setting unit. The maximum number of times of iterations setting unit sets a maximum number of times of the cyclic iterative operations of the bit estimating unit and the Turbo decoding unit. In a preferred embodiment, the deframing unit acquires a type of a bit generated at a transmitting-end speech coder; the maximum number of times of iterations setting unit sets the maximum number of times of the cyclic iterative operations of the bit estimating unit and the Turbo decoding unit in the joint decoding unit according to the type of the bit. The Turbo decoding method setting unit sets a Turbo decoding method used by the Turbo decoding unit during the cyclic iterative operations of the bit estimating unit and the Turbo decoding unit.

According to those embodiments, the unequal error protection strategy may be employed to adaptively set the number of times of iterations of the Turbo decoder and the decoding scheme, thereby reducing the number of times of decoding iterations, saving the storage space, and further improving the performance of the LTE-Advanced system.

The present invention further relates to a logic part readable program that enables, when being executed by a logic part, the logic part to work as the aforementioned apparatus or to implement the aforementioned method.

The present invention further relates to a logic part readable tangible storage medium that stores the aforementioned logic part readable program.

To be noted, the term “comprise/include/have” used herein specifies the presence of feature, element, step or component, not excluding the presence or addition of one or more other features, elements, steps or components.

The above general descriptions and the following detailed descriptions made with reference to the drawings are all schematic, rather than limitations to the protection scope of the present invention.

### BRIEF DESCRIPTION OF THE DRAWINGS

The above and other objectives, features and advantages of the present invention will be more clearly understood from the following detailed descriptions made with reference to the drawings. The same or similar reference signs denote the same or similar elements throughout the drawings.

FIG. 1 illustrates a schematic diagram of a mobile phone used as a receiver according to an embodiment of the present invention;

FIG. 2 illustrates a schematic block diagram of a receiver according to an embodiment of the present invention;

FIG. 3 illustrates a schematic block diagram of a JSCD apparatus according to an embodiment of the present invention;

FIG. 4 illustrates a schematic block diagram of a wrong speech frame judging unit according to an embodiment of the present invention;

FIG. 5 illustrates a schematic block diagram of a joint decoding necessity judging unit according to an embodiment of the present invention;

FIG. 6 illustrates a joint decoding unit according to an embodiment of the present invention;

FIG. 7 illustrates a JSCD apparatus according to another embodiment of the present invention;

FIG. 8 illustrates a JSCD apparatus according to still another embodiment of the present invention;

FIG. 9 illustrates a JSCD necessity judging method according to an embodiment of the present invention;

FIG. 10 illustrates a JSCD necessity judging method according to another embodiment of the present invention;

FIG. 11 illustrates a flowchart of a joint decoding processing according to an embodiment of the present invention; and

FIG. 12 illustrates a flowchart of a joint decoding processing according to another embodiment of the present invention.

### DESCRIPTION OF THE EMBODIMENTS

The specific embodiments of the present invention will be described as follows with reference to the drawings. Those embodiments are just exemplary rather than limitations to the protection scope of the present invention. It shall be noted that, in order to keep clearness, the descriptions of the technologies which are known to a person skilled in the art and may confuse the understanding of the present invention when being described are omitted herein.

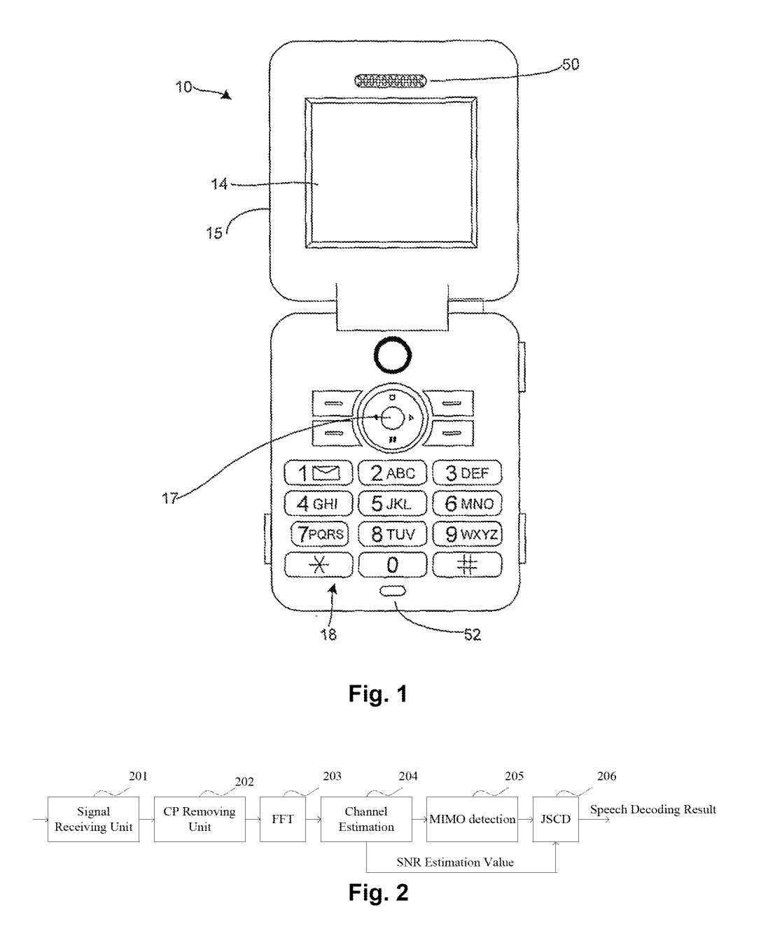

FIG. 1 illustrates a schematic diagram of a mobile phone used as a receiver according to an embodiment of the present invention. As illustrated in FIG. 1, a mobile phone 10 may be a flip phone having a cover 15 movable between an open position and a closed position. In FIG. 1, the cover 15 is illustrated as being located at the open position. It shall be appreciated that the mobile phone 10 may be other structure such as a “bar phone” or a “slide phone”.

The mobile phone 10 may include a display 14 that displays information such as operating state, time, telephone number, telephone directory, menus, etc. to the user, so that the user can utilize various features of the mobile phone 10. The display 14 may be further configured to visually display the content received by the mobile phone 10 and/or retrieved from a memory (not illustrated) of the mobile phone 10. The display 14 may be configured to present images, videos and other graphics (e.g., photos, mobile TV programs and game-related videos) to the user.

A keypad 18 provides multiple user input operations. For example, the keypad 18 may include alphanumeric keys that allow alphanumerical information (e.g., telephone number, telephone list, telephone directory, notepad, text, etc.) to be input. In addition, the keypad 18 may include specific function keys 17, such as a “call send” key for initiating or answering a phone call, and a “call end” key for ending or hanging up the phone call. The specific function keys may further include a menu navigation key and a selection key which conveniently perform navigation through menus displayed on the display 14. For example, a pointing device and/or a navigation key may be provided to receive a directional input from the user. In addition, the display 14 and the keypad 18 may be used in combination to realize the soft key function. The receiver 10 further includes parts essential for realizing its functions, such as antenna and microcontroller.

To be noted, the receiver of the present invention is not limited to the mobile phone, but any receiver capable of receiving the AMR speech coded signal.

FIG. 2 illustrates a schematic block diagram of a receiver according to an embodiment of the present invention. As illustrated in FIG. 2, a receiver 200 according to the present invention includes a signal receiving unit 201, a CP removing unit 202, a Fast Fourier Transforming (FFT) unit 203, a channel estimating unit 204, a Multi-Input Multi-Output (MIMO) detecting unit 205, and a JSCD apparatus 206. The channel estimating unit 204 performs a channel estimation to obtain a channel estimation value, determines an SNR estimation value of the received signal, and transmits the SNR estimation value to the JSCD apparatus 206. The functions and implementations of the signal receiving unit 201, the CP removing unit 202, the FFT unit 203, the channel estimating unit 204 and the MIMO detecting unit 205 can be achieved in any method known to a person skilled in the art at present or in future, thus the details are omitted herein.

In an alternative embodiment, the MIMO detecting unit 205 can be omitted.

To be noted, the drawing is just exemplary, rather than limitations to the protection scope of the present invention.

Next, the JSCD apparatus 206 will be detailedly described.

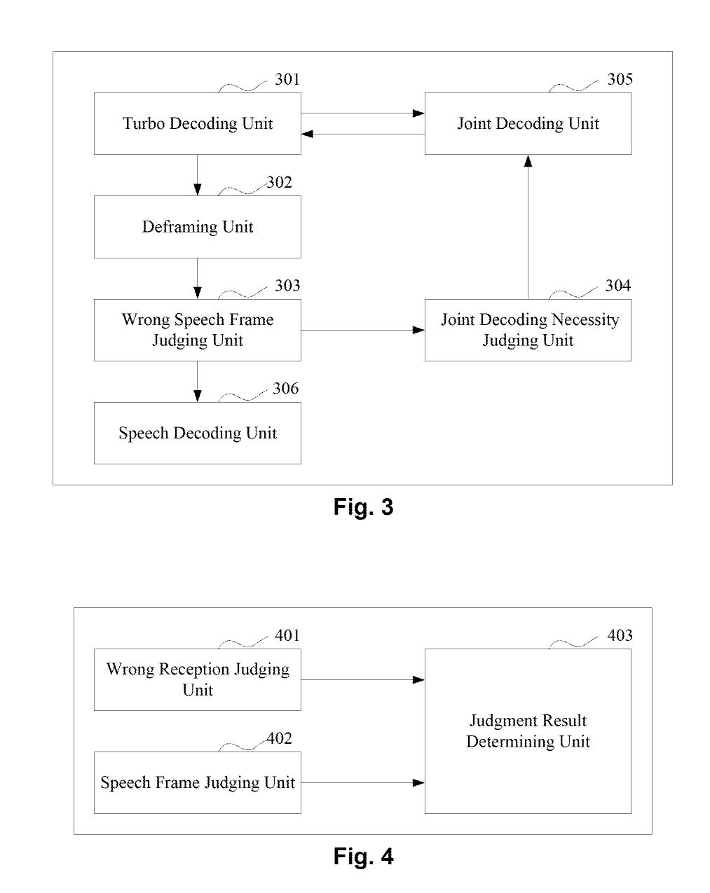

FIG. 3 illustrates a schematic block diagram of a JSCD apparatus according to an embodiment of the present invention. As illustrated in FIG. 3, according to an embodiment of the present invention, the JSCD apparatus includes a Turbo decoding unit 301, a deframing unit 302, a wrong speech frame judging unit 303, a joint decoding necessity judging unit 304, a joint decoding unit 305 and a speech decoding unit 306.

The Turbo decoding unit 301 performs a Turbo decoding of an input current frame signal, and outputs an index value bit probability and a decoding hard decision result.

The deframing unit 302 performs a deframing according to the decoding hard decision result obtained by the Turbo decoding unit, and acquires a source coding rate according to frame header information obtained through the deframing.

The wrong speech frame judging unit 303 judges whether the current frame is a wrong speech frame. When the current frame is judged as a wrongly decoded speech frame, a wrong speech frame indication signal is output to the joint decoding necessity judging unit 304; when the current frame is judged as a non-speech frame or a correct speech frame, corresponding control signal is output.

FIG. 4 illustrates a schematic block diagram of a wrong speech frame judging unit according to an embodiment of the present invention. As illustrated in FIG. 4, the wrong speech frame judging unit comprises a wrong reception judging unit 401, a speech frame judging unit 402 and a judgment result determining unit 403. The wrong reception judging unit 401 may include either or both of a CRC checking module and a reception quality determining module. The CRC checking module performs a CRC check of a frame body and determines whether there is a wrong speech. The reception quality determining module may determine whether there is a wrong speech according to a parameter indicating the reception quality obtained by deframing by the deframing unit. The speech frame judging unit 402 judges whether the current frame is a speech frame. The judgment result determining unit 403 determines a final judgment result according to the judgment results of the wrong reception judging unit 401 and the speech frame judging unit 402, and outputs a signal indicating corresponding judgment result. Although the wrong reception judging unit 401 and the speech frame judging unit 402 are illustrated as being operative in parallel in the drawing, the operations of them may be performed orderly or partially in parallel.

When the current frame is judged as a non-speech frame or a correct speech frame, the speech decoding unit 306 may perform the following processing. For example, when the current frame is judged as a correct speech frame, the frame body of the current frame is directly transmitted to a speech decoding module. When the current frame is judged as a background noise frame, it is input into a background noise function selecting module and then into the speech decoding module. When the current frame is judged as a null frame, it is input into a silent frame replacing module and then into the speech decoding module. When it is judged that the reception type cannot be decided, or the silence description (SID) is wrong, etc., the current frame is input into an error concealing module and then into the speech decoding module and so on. The background noise function selecting module, the silent frame replacing module, the error concealing module and the speech decoding module etc., included in the speech decoding unit 306 can be implemented with various methods well known to a person skilled in the art, and the implementation of the present invention will not be influenced by any of the above methods, thus the details are omitted herein.

The joint decoding necessity judging unit 304 judges whether to perform a JSCD when the wrong speech frame judging unit 303 judges that the current frame is a wrongly decoded speech frame.

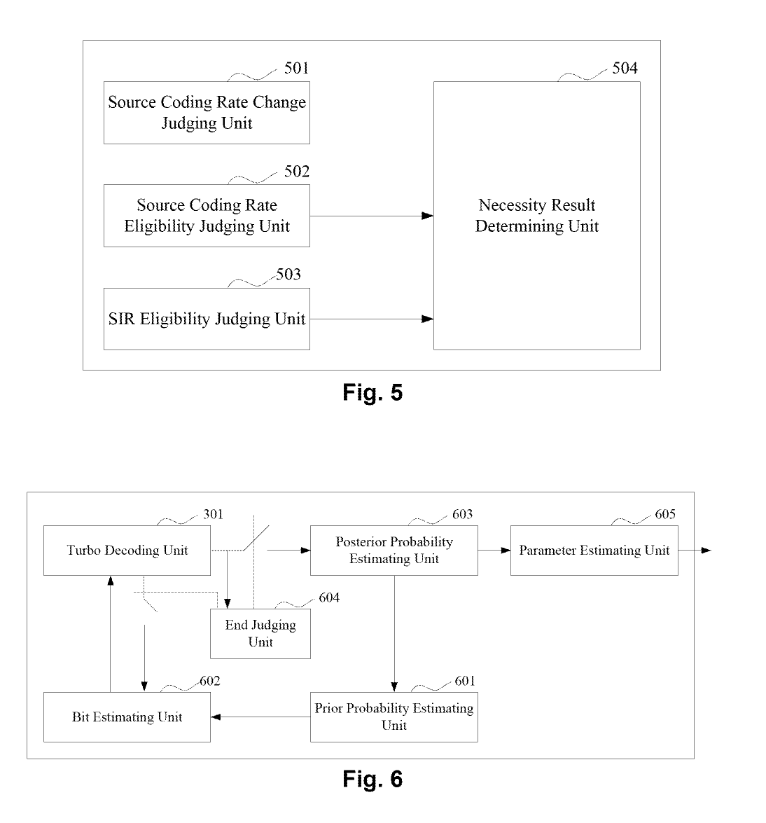

FIG. 5 illustrates a schematic block diagram of a joint decoding necessity judging unit according to an embodiment of the present invention. As illustrated in FIG. 5, the joint decoding necessity judging unit according to an embodiment of the present invention includes a source coding rate change judging unit 501, a source coding rate eligibility judging unit 502, a current frame SIR eligibility judging unit 503 and a necessity result determining unit 504. The source coding rate change judging unit 501 judges whether a source coding rate of the current frame is the same as that of the previous frame. The source coding rate eligibility judging unit 502 judges whether the source coding rate of the current frame is less than a predetermined source coding rate threshold. The current frame SIR eligibility judging unit 503 judges whether an SIR of the current frame is lower than a predetermined SIR threshold. In an embodiment, the necessity result determining unit 504 determines that a JSCD is necessary, when the source coding rate change judging unit 501 judges that the source coding rate of the current frame is the same as that of the previous frame, the source coding rate of the current frame is less than the source coding rate threshold, and the SIR of the current frame is lower than the SIR threshold. Otherwise it is judged that a JSCD shall not be performed, and corresponding signal is output to the speech decoding unit 306 (such as the error concealing module in the speech decoding unit 306).

To be noted, the meaning of the SIR shall be generally understood in the present invention, and it includes the signal to interference and noise ratio, the signal to interference ratio, the signal to noise ratio, etc.

When the joint decoding necessity judging unit 304 determines that the JSCD is necessary, the joint decoding unit 305 and the Turbo decoding unit decodes the current frame together.

FIG. 6 illustrates a joint decoding unit according to an embodiment of the present invention. For the convenience of description, the Turbo decoding unit 301 is also illustrated therein.

As illustrated in FIG. 6, according to an embodiment of the present invention, the joint decoding unit 305 includes a prior probability estimating unit 601, a bit estimating unit 602, a posterior probability estimating unit 603, an end judging unit 604 and a parameter estimating unit 605.

The prior probability estimating unit 601 calculates an index value prior probability according to an index value posterior probability. The index value posterior probability for example comes from a posterior index value estimation obtained by Turbo decoding based on the previous frame.

The bit estimating unit 602 calculates a new index value bit probability according to the index value prior probability from the prior probability estimating unit 601 and the index value bit probability from the Turbo decoding unit, and outputs the new index value bit probability to the Turbo decoding unit.

The Turbo decoding unit 301 performs a Turbo decoding of the current frame again according to the index value bit probability from the bit estimating unit 602 and the reception information of the current frame, and outputs the index value bit probability to the bit estimating unit 602 under the control of the joint decoding end judging unit 604, thereby realizing the JSCD.

The joint decoding end judging unit 604 judges whether the decoding result of the Turbo decoding unit 301 is correct, or whether a predetermined number of times of cycles is reached. If the predetermined number of times of cycles is reached or the decoding result is correct, the joint decoding end judging unit 604 judges that the joint decoding is ended, disconnects the bit estimating unit 602 from the Turbo decoding unit 301, and causes the index value bit probability output from the Turbo decoding unit to be output to the posterior probability estimating unit.

The posterior probability estimating unit 602 estimates an index value posterior probability according to the index value bit probability from the Turbo decoding unit, and outputs it to the parameter estimating unit 605.

The parameter estimating unit 605 performs a parameter estimation (e.g., estimating parameters such as Linear Spectral Frequency (LSF) sub-vector index, adaptive codebook index, pulse position and pulse symbol) according to the posterior probability estimated by the posterior probability estimating unit based on an MMSE principle or an MAP principle. The parameter estimation value is transferred to the speech decoding module.

For the joint decoding process performed by the joint decoding unit and the Turbo decoding unit in coordination, please refer to Joint Source-Channel Decoding Algorithm based on Parameter Redundancy Allocation Scheme and Variable Parameter Estimation Criterion for GSM EFR (authors: Zhou lin and Wu Zhenyang) publicized in Electronics and Information Journal, 2008 issue 11, which is incorporated herein by reference as if it was completely elaborated herein.

To be noted, the joint decoding process performed by the joint decoding unit and the Turbo decoding unit in coordination is not limited to the above described process. For example, the posterior probability and the prior probability may be calculated during each iteration. The joint decoding process performed by the joint decoding unit and the Turbo decoding unit in coordination may also be performed with reference to the following literatures:

N. Gortz. On the iterative approximation of optimal joint source-channel decoding [J]. IEEE transaction on selected areas in communications 2001, 19(9): 1662-1670;

M. Adrat, P. Vary, J. Spittka. Iterative source-channel decoder using extrinstic information from softbit-source decoding [C]. In the proceedings of ICASSP'01. Salt Lake City, USA. 2001:2653-2656.

Obviously, the joint decoding unit of the present invention may further include a storage unit configured to store the posterior probability value and the source coding rate of the previous frame.

The JSCD according to the embodiment of the present invention includes the iterative channel decoding and the posterior probability calculation individually. Firstly, the iterative channel decoding is performed, and then the posterior probability is calculated by using the bit likelihood obtained through the channel decoding. It is unnecessary to calculate posterior information and prior information during each iteration, thereby reducing the calculation amount, simplifying the structure and calculation process of the joint decoding, and decreasing the performance loss caused by the assumption of the index value bit independence.

To be noted, the joint decoding unit as illustrated in FIG. 6 is just schematic, and the joint decoding unit used in the joint decoding method as illustrated in FIG. 12 may also be employed together with the Turbo decoding unit.

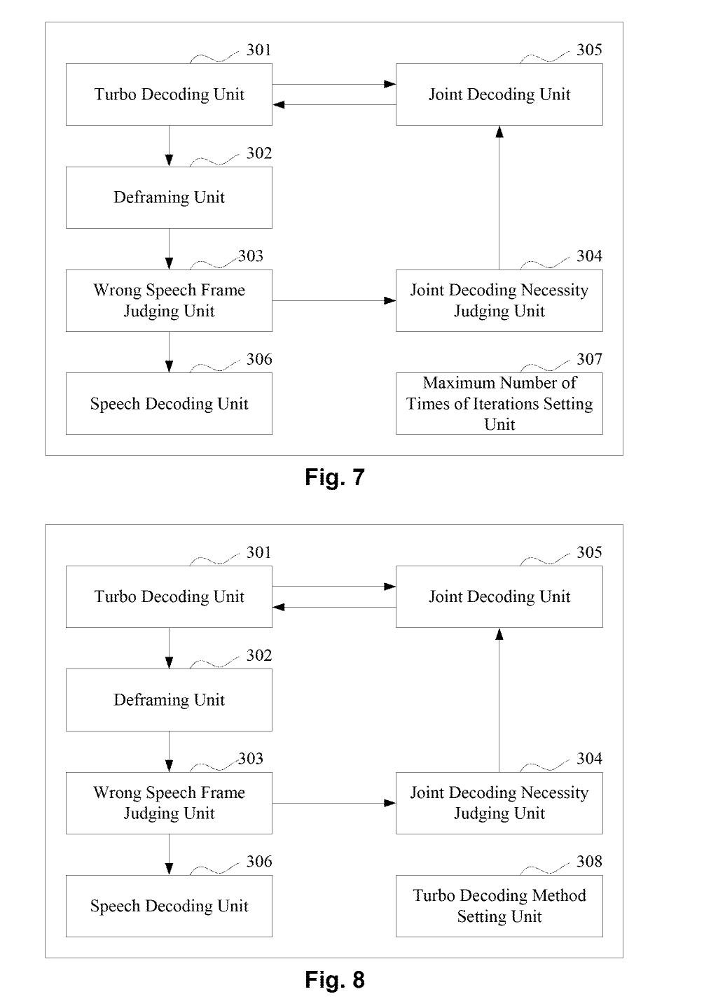

FIG. 7 illustrates a JSCD apparatus according to another embodiment of the present invention. As compared with the JSCD apparatus illustrated in FIG. 3, the JSCD apparatus illustrated in FIG. 7 further includes a maximum number of times of iterations setting unit 307.

In this embodiment, the deframing unit 302 further acquires a parameter type, i.e., type A, B or C of the bit generated by the transmitting-end speech coder. The three types of bits are suitable for different error protection levels in the network as described previously, and herein are omitted.

The maximum number of times of iterations setting unit 307 sets the number of times of iterations as follows:

1) for the bits with parameter type A: the number of times of iterations is set to be larger than a first predetermined number of times; and

2) for the bits with parameter type B or C: the number of times of iterations is set to be smaller than a second predetermined number of times.

The first predetermined number of times and the second predetermined number of times may be equal to each other, e.g., both being 2; or different from each other, e.g., the first predetermined number of times may be set as 4, while the second predetermined number of times may be set as 2.

Different predetermined number of times may also be set for types B and C.

The end judging unit 604 judges whether the iteration shall be ended according to a maximum number of times of iterations set by the maximum number of times of iterations setting unit.

To be noted, it is just an embodiment to set the number of times of cycles according to the type of the bit generated by the transmitting-end speech coder. Upon demand, an appropriate number of times of cycles may be determined according to the performance requirement and the arithmetic speed for implementing corresponding hardware such as the Turbo decoding unit and the bit estimating unit. In that case, the deframing unit is not required to acquire the type of the bit generated by the transmitting-end speech coder.

FIG. 8 illustrates a JSCD apparatus according to still another embodiment of the present invention. As compared with the JSCD apparatus illustrated in FIG. 3, the JSCD apparatus illustrated in FIG. 8 further includes a Turbo decoding method setting unit 308.

The Turbo decoding method setting unit 308 sets a decoding algorithm used by the Turbo decoding unit during each iteration. For example, the decoding algorithm used in the Turbo decoding may be set as follows:

1) The Turbo decoding only uses the Max-Log-MAP algorithm during the iteration.

2) The Turbo decoding only uses the SOVA algorithm during the iteration.

3) The Turbo decoding only uses the Log-MAP algorithm during the iteration.

4) The Turbo decoding uses a joint algorithm composed of any two or more of the above three algorithms during the iteration. For example, the SOVA algorithm may be used during the first cycle, and the Log-MAP algorithm may be used during the second cycle.

For the Max-Log-MAP algorithm, the complexity is the lowest and the performance is relatively poor. For the SOVA algorithm, the calculation speed is fast but the performance is slightly poor, and when the requirement of the real-time performance is high, only the SOVA algorithm is used during the iteration. The Log-MAP algorithm is highly reliable and accurate, but the calculation is complex, and the decoding reliability can be improved by just using the Log-MAP algorithm during the iteration. In a case where the Turbo decoding uses the joint algorithm during the iteration, firstly an accurate algorithm such as the Log-MAP algorithm may be used, and then an algorithm of simple calculation (e.g., the Max-Log-MAP algorithm or the SOVA algorithm) is used during the subsequent iteration. Or, a simple algorithm is used during the first iteration, and then an accurate algorithm is used during the subsequent iteration by using bit estimation information, thereby reducing the algorithm convergence time.

Obviously, the embodiments of FIGS. 7 and 8 may be used in combination.

The flow of the exemplary processing performed by the above receiver and its components according to the present invention will be described as follows. The descriptions of the apparatus may promote the understanding of the method performed by the apparatus, and the descriptions of the method performed by the apparatus may promote the understanding of the apparatus.

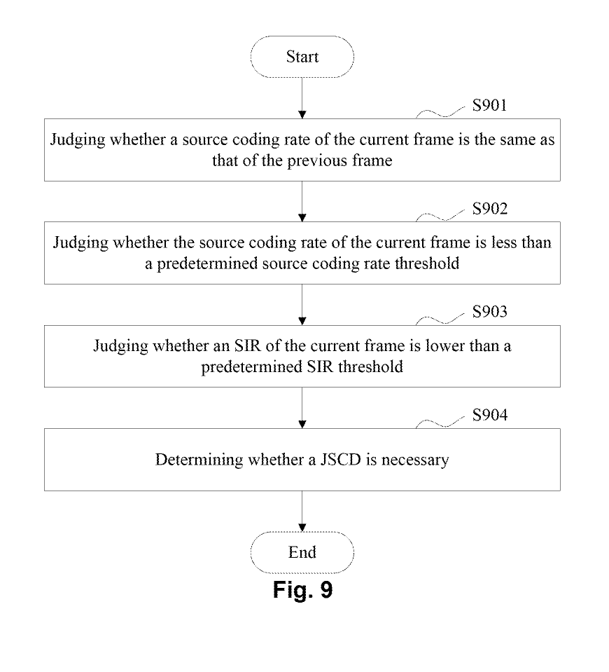

FIG. 9 illustrates a JSCD necessity judging method according to an embodiment of the present invention. As illustrated in FIG. 9, firstly in step S901, judging whether a source coding rate of the current frame is the same as that of the previous frame. Next, in step S902, judging whether the source coding rate of the current frame is less than a predetermined source coding rate threshold. Next, in step S903, judging whether an SIR of the current frame is lower than a predetermined SIR threshold. Finally, in step S904, determining that a JSCD is necessary when the source coding rate of the current frame is the same as that of the previous frame, the source coding rate of the current frame is less than the source coding rate threshold, and the SIR of the current frame is lower than the SIR threshold.

Obviously, the order from step S901 to step S903 can be changed, and those steps can also be performed concurrently.

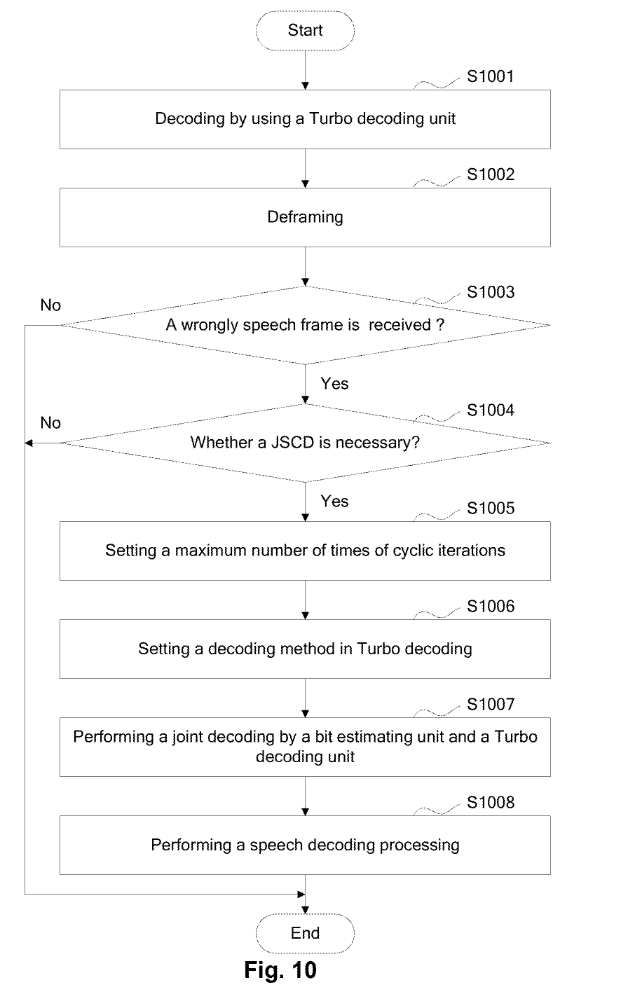

FIG. 10 illustrates a JSCD necessity judging method according to another embodiment of the present invention. As illustrated in FIG. 10, according to the JSCD method, firstly in step S1001, decoding a received signal by using a Turbo decoding unit. Next in step S1002, deframing the received signal decoded by the Turbo decoding unit to obtain a parameter type and a source coding rate. Next in step S1003, determining whether the current frame is a wrongly received speech frame. When it is determined that the current frame is a wrongly received speech frame (S1003, Yes), judging whether a JSCD is necessary in step S1004. In this step, the method illustrated in FIG. 9 may be used. When it is judged that the JSCD is necessary (S1004, Yes), setting a maximum number of times of the cyclic iterative operations (joint decoding operations) of the bit estimating unit and the Turbo decoding unit in step S1005. In one embodiment, the maximum number of times of the cyclic iterative operations of the bit estimating unit and the Turbo decoding unit is set according to the type of the bit generated by the transmitting-end speech coder (which is obtained by deframing in step S1002), or according to the time (e.g., the non-peak period), the performance requirement, the client type (the maximum number of times may be larger for the clients requiring a high communication quality), etc. Next in step S1006, setting the Turbo decoding method used in the Turbo decoding during the cyclic iterative operations of the bit estimating unit and the Turbo decoding unit. Next in step S1007, performing a joint decoding, i.e., the bit estimating unit and the Turbo decoding unit operate in coordination to decode the current frame according to the set maximum number of times of the cyclic iterative operations and the set Turbo decoding method. The parameter estimated after the decoding is transmitted to step S1008 for a speech decoding processing. On the other hand, when it is judged in step S1003 that the current frame is not a wrongly received speech frame, or it is judged in step S1004 that the JSCD is unnecessary, the flow directly enters step S1008 to perform a speech decoding processing. Step S1008 includes performing a speech decoding by using a speech decoder, and necessary operations such as a silent frame replacement, a background noise function selection, and an error concealment.

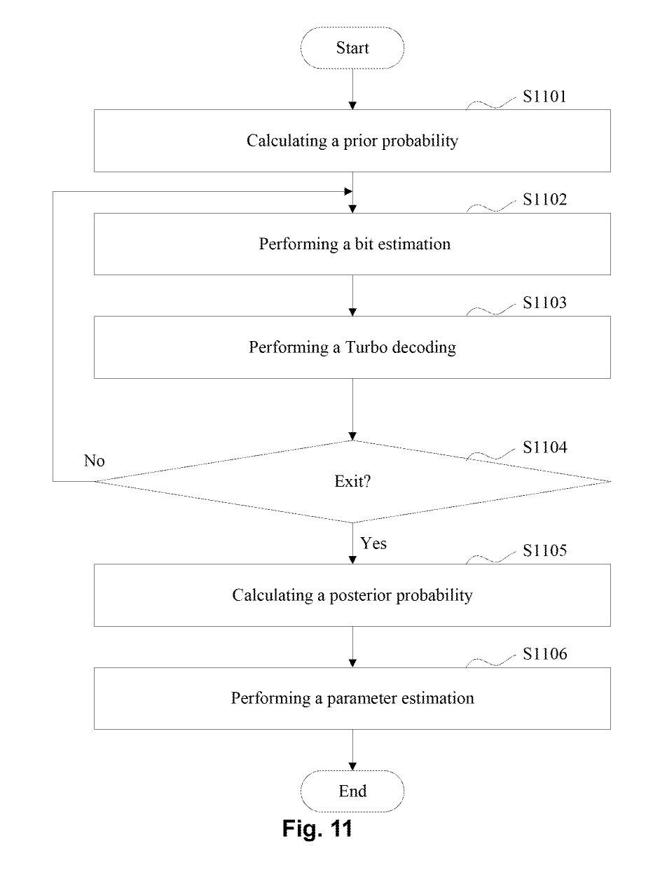

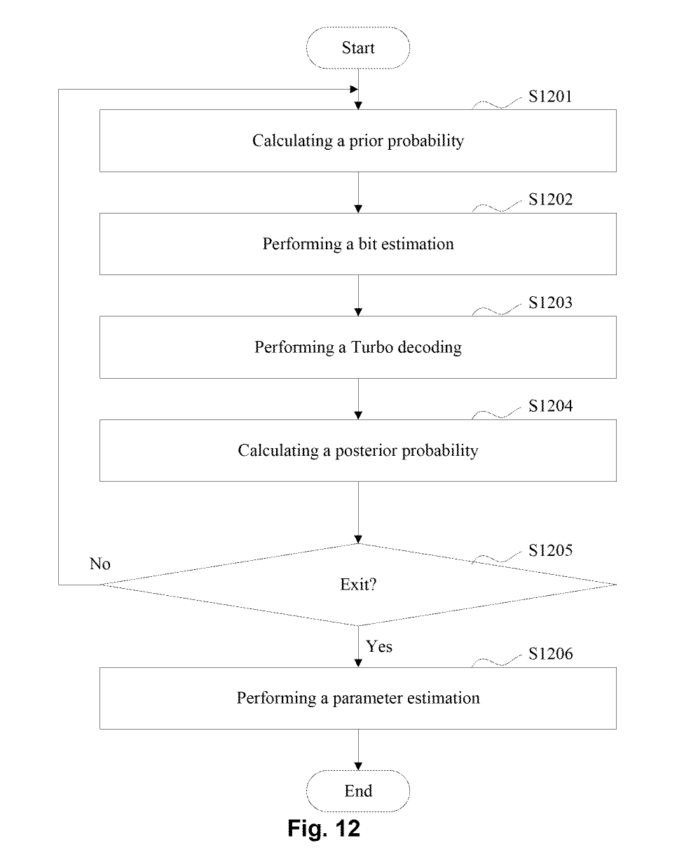

FIG. 11 illustrates a flowchart of a joint decoding processing according to an embodiment of the present invention. As illustrated in FIG. 11, according to an embodiment of the present invention, when the bit estimating unit and the Turbo decoding unit perform a joint decoding, firstly a prior probability may be calculated in step S1101 to estimate a prior probability. The prior probability may be estimated based on a posterior probability of the previous frame. Next in step S1102, a bit estimation is performed according to the prior probability and an index value bit probability obtained by Turbo decoding. Next in step S1103, a Turbo decoding is performed again according to a estimation result of the bit. In step S1104, it is judged whether the joint decoding shall be ended according to the decoding result of the Turbo. For example, when the number of times of cycles is larger than a predetermined number of times (e.g., a set number of times), or when the decoding result of the Turbo is correct, it is judged that the joint decoding shall be ended. When it is judged that the joint decoding shall be ended (step S1104, Yes), a posterior probability estimation (step S1105) and a parameter estimation (step S1106) are performed. On the other hand, when it is judged that the joint decoding shall not be ended (step S1104, No), the flow returns to step S1102 to continue the bit estimation and the subsequent processing.

When a decoding is performed according to the bit type, assuming that the maximum number of times of cycles is set as 4 for the bits of type A, set as 3 for the bits of type B, and set as 2 for the bits of type C, the joint decoding may firstly decode for the bits of type A (at most 4 times), then decode for the bits of type B (at most 3 times), and finally decode for the bits of type C (at most 2 times), totally 9 times, i.e., decode for different types of bits seriatim. In addition, in an embodiment, the cyclic iterations may be performed for totally 4 times, i.e., the first and second cyclic iterations are to decode for the bits of types A to C, the third cyclic iteration is to decode for the bits of types B and A, and the fourth cyclic iteration is to only decode for the bits of type A i.e., the decoding is performed for bits of all the type and then for bits of parts of the all the type.

FIG. 12 illustrates a flowchart of a joint decoding processing according to another embodiment of the present invention. As illustrated in FIG. 12, according to another embodiment of the present invention, when the bit estimating unit and the Turbo decoding unit perform a joint decoding, firstly a prior probability may be calculated in step S1201 to estimate a prior probability. The prior probability may be estimated based on a posterior probability of the previous frame. Next in step S1202, a bit estimation is performed according to the prior probability and an index value bit probability obtained by Turbo decoding. Next in step S1203, a Turbo decoding is performed again according to a estimation result of the bit. In step S1204, a posterior probability is estimated. In step S1205, it is judged whether the joint decoding shall be ended according to the decoding result of the Turbo. For example, when the number of times of cycles is larger than a predetermined number of times (e.g., a set number of times), or when the decoding result of the Turbo is correct, it is judged that the joint decoding shall be ended. When it is judged that the joint decoding shall be ended (step S1205, Yes), a parameter estimation (step S1206) is performed and the processing is ended. On the other hand, when it is judged that the joint decoding shall not be ended (step S1205, No), the flow returns to step S1201 to continue the prior probability estimation and the subsequent processing.

The above apparatuses and methods of the present invention may be implemented by hardware, or a combination of hardware and software. The present invention also relates to a logic part readable program which when being executed by a logic part, enables the logic part to implement the aforementioned apparatus or constituent parts, or enables the logic part to implement the aforementioned methods or steps. The logic part for example may be a field programmable logic part, a microprocessor, a processor used in a computer, etc. The present invention further relates to a storage medium for storing the above program, such as hard disc, magnetic disc, optical disc, DVD, flash, magnetic optical disc, memory card, memory stick, etc.

Although the present invention is described in conjunction with the embodiments, a person skilled in the art shall appreciate that those descriptions are just exemplary, rather than limitations to the protection scope of the present invention. According to the spirit and principle of the present invention, a person skilled in the art can make various modifications and amendments thereto, which also fall within the protection scope of the present invention.

What is claimed is:

1. A Joint Source-Channel Decoding (JSCD) necessity judging method, comprising:
judging whether a source coding rate of the current frame is the same as that of the previous frame;
judging whether the source coding rate of the current frame is less than a predetermined source coding rate threshold;
judging whether a Signal to Interference Ratio (SIR) of the current frame is lower than a predetermined SIR threshold; and
determining that a JSCD is necessary when the source coding rate of the current frame is the same as that of the previous frame, the source coding rate of the current frame is less than the source coding rate threshold, and the SIR of the current frame is lower than the SIR threshold.

2. A Joint Source-Channel Decoding (JSCD) method, comprising:
decoding a received signal by using a Turbo decoding unit;
deframing the received signal decoded by the Turbo decoding unit to obtain a source coding rate;
determining whether the current frame is a wrongly received speech frame;
judging whether a JSCD is necessary by using the method of claim 1, when it is determined that the current frame is a wrongly received speech frame; and
performing a JSCD by using cyclic iterative decoding operations of a bit estimating unit and the Turbo decoding unit, when it is judged that the JSCD is necessary.

3. The method according to claim 2, further comprising:
setting a maximum number of times of the cyclic iterative decoding operations of the bit estimating unit and the Turbo decoding unit.

4. The method according to claim 3, wherein the setting comprises:
acquiring a type of a bit generated at a transmitting-end speech coder;
setting the maximum number of times of the cyclic iterative decoding operations of the bit estimating unit and the Turbo decoding unit, or setting maximum numbers of times of cyclic iterative decoding operations for various types of bits respectively, according to the type of the bit.

5. The method according to claim 2, further comprising:
setting a Turbo decoding method used by the Turbo decoding unit during the cyclic iterative decoding operations of the bit estimating unit and the Turbo decoding unit.

6. A Joint Source-Channel Decoding (JSCD) apparatus, comprising:
a Turbo decoding unit configured to decode a received signal;
a deframing unit configured to deframe the received signal decoded by the Turbo decoding unit to obtain a source coding rate;
a wrong speech frame judging unit configured to determine whether the current frame is a wrongly received speech frame;
whether a JSCD is necessary is judged by using the JSCD necessity judging apparatus of claim 6 according to the source coding rate obtained by the deframing unit; and
a joint decoding unit configured to perform a JSCD by using cyclic iterative operations of a bit estimating unit and the Turbo decoding unit.

7. The JSCD apparatus according to claim 6, further comprising:
a maximum number of times of iterations setting unit configured to set a maximum number of times of the cyclic iterative decoding operations of the bit estimating unit and the Turbo decoding unit.

8. The JSCD apparatus according to claim 7, wherein,
the deframing unit acquires a type of a bit generated at a transmitting-end speech coder;
the maximum number of times of iterations setting unit sets the maximum number of times of the cyclic iterative decoding operations of the bit estimating unit and the Turbo decoding unit, or sets maximum numbers of times of cyclic iterative decoding operations for various types of bits respectively, according to the type of the bit.

9. The JSCD apparatus according to claim 6, further comprising:
a Turbo decoding method setting unit configured to set a Turbo decoding method used by the Turbo decoding unit during the cyclic iterative operations of the bit estimating unit and the Turbo decoding unit.

10. A receiver that comprises the apparatus according to claim 6.

11. The receiver according to claim 10, comprising a channel estimating unit that estimates an SIR, the JSCD apparatus or the JSCD method uses the SIR when judging whether a JSCD is necessary.
